(19) United States
(12) Patent Application Publication
(10) Pub. No.: US 2020/0159037 A1
(43) Pub. Date: May 21, 2020

(54) VIRTUAL REALITY (VR) HEAD-MOUNTED DISPLAY DEVICE, VR DISPLAY METHOD AND VR DISPLAY SYSTEM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Wenyu LI, Beijing (CN); Hao ZHANG, Beijing (CN); Lili CHEN, Beijing (CN); Yali LIU, Beijing (CN); Yukun SUN, Beijing (CN); Jinghua MIAO, Beijing (CN); Xuefeng WANG, Beijing (CN); Jinbao PENG, Beijing (CN); Bin ZHAO, Beijing (CN); Xi LI, Beijing (CN); Lixin WANG, Beijing (CN); Jianwen SUO, Beijing (CN); Qingwen FAN, Beijing (CN)

(21) Appl. No.: 16/500,198

(22) PCT Filed: Mar. 18, 2019
(86) PCT No.: PCT/CN2019/078536

§ 371 Date: Oct. 2, 2019

(30) Foreign Application Priority Data
Mar. 30, 2018 (CN) 201810278238.9

(51) Int. Cl. G02B 30/25; G06F 3/01; G06F 1/16; G02B 27/00

(52) U.S. Cl. CPC G02B 30/25; G02B 27/0081; G06F 1/163; G06F 3/011

(57) ABSTRACT

A VR head-mounted display device, a VR display method and a VR display system are provided, including: a first convex lens and a second convex lens, a first polarizer and a second polarizer respectively disposed between the two convex lenses and two eyes of a user of the VR head-mounted display device, and a display screen. The display screen simultaneously outputs a first display image having a first polarization direction and a second display image having a second polarization direction, the first polarization direction being orthogonal to the second polarization direction; the first polarizer having a first polarization direction and the second polarizer having a second polarization direction.

### CROSS-REFERENCE TO RELATED APPLICATIONS

The application claims benefit of Chinese Patent Application No. 201810278238.9, entitled “VR Head-mounted Display Device, VR Display Method and VR Display System”, filed on Mar. 30, 2018, to CNIPA, the entire disclosure of which is incorporated herein by reference.

### TECHNICAL FIELD

The present disclosure relates to a virtual reality (VR) head-mounted display device, a VR display method, and a VR display system.

### BACKGROUND

The helmet display is the earliest virtual reality (VR) display. The helmet display is used to close a person's visual and auditory sense to the outside world and guide a user to create a feeling in the virtual environment. The display principle is that a left eye screen and a right eye screen respectively display an image of the left eye and an image of the right eye, and the person's eyes obtain such difference information and have a stereoscopic sense in the mind. A traditional VR head-mounted display system mostly uses the dual-screen form, that is, the left and right eyes of the person each corresponding to one screen, and an observer respectively sees the images on the respective screens through the two eyes to obtain a stereoscopic visual sense. However, this system has a natural structure design defect, that is, a light blocking plate is needed between two lenses and the two screens, that is, a lens barrel structure. The original intention of this design is to prevent the two eyes of the observer from seeing the same screen and creating visual confusion. However, the problem is that the angle of visual field of the system is limited and is difficult to increase. Moreover, strict alignment relationship is required when mounting and fixing the two screens, and the structure design precision is required to be high. At the same time, the light blocking plate disposed in the middle of the two screens also increases the structure complexity and weight of the system.

Although the patent of the publication number CN205608305U is changed to be a single screen display, a liquid crystal layer is added in front of the display screen, and the time-division multiplexing function is used to divide the output images corresponding to the left and right eyes in time, and the images corresponding to the left and right eyes are filtered by the polarization function in front of the two eyes. But this improvement increases the complexity of the system, affects system stability, and increases cost.

### SUMMARY

Embodiments of the present disclosure provide a virtual reality (VR) head-mounted display device, a VR display method and a VR display system.

At least one embodiment of the present disclosure provides a VR head-mounted display device, comprising: a display screen configured to simultaneously output a first display image having a first polarization direction and a second display image having a second polarization direction, the first polarization direction being orthogonal to the second polarization direction; a first convex lens configured to enlarge the first display image and a second convex lens configured to enlarge the second display image; and a first polarizer disposed between the first convex lens and a left eye of a user of the VR head-mounted display device, and a second polarizer disposed between the second convex lens and a right eye of the user of the VR head-mounted display device. The first polarizer has a first polarization direction and the second polarizer has a second polarization direction.

For example, the display screen comprises: a display component; third polarizers having the first polarization direction, disposed in a light exiting direction of the display component, and configured to output the first display image; and fourth polarizers having the second polarization direction, disposed in the light exiting direction of the display component, and configured to output the second display image.

For example, the third polarizers are of a first polarizer group, positions of the polarizers in the first polarizer group corresponding to positions of odd columns of pixels of the display component; and the fourth polarizers are of a second polarizer group, positions of the polarizers in the second polarizer group corresponding to positions of even columns of pixels of the display component.

For example, the display component is an LCD display component or an OLED display component, and the third polarizers and the fourth polarizers are attached to a surface of the light exiting direction of the display component.

For example, the third polarizers and the fourth polarizers are linear polarizers.

For example, the first polarizer and the second polarizer respectively are a polarizing film formed on a surface of the first convex lens facing the left eye and a polarizing film formed on a surface of the second convex lens facing the right eye.

At least one embodiment of the present disclosure provides a method of performing VR display by using the VR head-mounted display device, comprising: the display screen simultaneously outputting the first display image having the first polarization direction and the second display image having the second polarization direction, the first polarization direction being orthogonal to the second polarization direction; the first convex lens and the second convex lens respectively enlarging the first display image and the second display image; and the first polarizer outputting the enlarged first display image to the left eye of the user, and the second polarizer outputting the enlarged second display image to the right eye of the user.

For example, the display screen comprises a display component, third polarizers having a first polarization direction, and fourth polarizers having a second polarization direction, and the method comprises: disposing the third polarizers in the light exiting direction of the display component to output the first display image; and disposing the fourth polarizers in the light exiting direction of the display component to output the second display image.

For example, the third polarizers form the first polarizer group, and the fourth polarizer form the second polarizer group, and the method comprises: disposing the positions of the polarizers in the first polarizer group corresponding to the positions of the odd columns of pixels of the display screen; and disposing the positions of the polarizers in the second polarizer group corresponding to the positions of the even columns of pixels of the display screen.

At least one embodiment of the present disclosure provides an external VR display system, comprising the VR head-mounted display device.

At least one embodiment of the present disclosure provides an integrated VR display system, comprising the VR head-mounted display device.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 is a schematically structural diagram of an optical structure of a VR head-mounted display system;

FIG. 2 is a schematically structural diagram of an optical structure of a VR head-mounted display system provided according to an embodiment of the present disclosure;

FIG. 3 is a schematic diagram of a mode/manner of a screen outputting an image provided according to an embodiment of the present disclosure;

FIG. 4 is a schematic diagram of a mode of a screen outputting an image provided according to another embodiment of the present disclosure; and

FIG. 5 is a schematic diagram of a mode of a screen and lens polarization display provided according to an embodiment of the present disclosure.

### DETAILED DESCRIPTION

Technical solutions of the embodiments will be described in a clearly and completely way in connection with the drawings related to the embodiments of the disclosure. Apparently, the described embodiments are just a part but not all of the embodiments of the disclosure. Based on the described embodiments herein, one of ordinary skill in the art can obtain other embodiment(s), without any creative labor, which shall be within the scope of the present disclosure.

Unless otherwise defined, all the technical and scientific terms used herein have the same meanings as commonly understood by one of ordinary skill in the art to which the present disclosure belongs. The terms, such as ‘first,’ ‘second,’ or the like, which are used in the description and the claims of the present disclosure, are not intended to indicate any sequence, amount or importance, but for distinguishing various components. The terms, such as ‘comprise/comprising,’ ‘include/including,’ or the like are intended to specify that the elements or the objects stated before these terms encompass the elements or the objects and equivalents thereof listed after these terms, but not preclude other elements or objects. The terms, ‘on,’ ‘under,’ or the like are only used to indicate relative position relationship, and when the absolute position of the object which is described is changed, the relative position relationship may be changed accordingly.

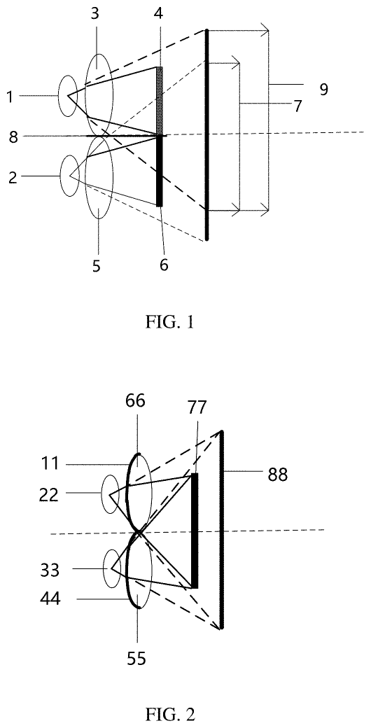

The inventor noticed that, as shown in FIG. 1, a virtual reality (VR) entire machine system is designed with a lens barrel structure. The lens barrel has two functions. One function is to connect and fix two lenses 3 and 5. The other function is to design a long barrel baffle 8 that extends from the lens to the middle of the two screens 4 and 6, preventing a left eye 1 from seeing a right screen 6 and a right eye 2 seeing a left screen 4, and thus avoiding mutual interference of binocular vision. For example, for the left eye 1, the left eye 1 in the figure is blocked by the lens barrel baffle 8 and can only see the rightmost end of the screen 4. The corresponding image region that is seen by the left eye 1 is region 9, and the overlap image region that is seen by the two eyes is region 7, which results in a small viewing field of the image seen by the two eyes.

As shown in FIG. 2, a VR head-mounted display device of an embodiment of the present disclosure includes: a display screen 77 for simultaneously outputting a first display image having a first polarization direction and a second display image having a second polarization direction, the first polarization direction being orthogonal to the second polarization direction; a first convex lens 66 for enlarging the first display image and a second convex lens 55 for enlarging the second display image; a first polarizer 11 disposed between the first convex lens 66 and the left eye 22 of the user of the VR head-mounted display device, and a second polarizer 44 disposed between the second convex lens 55 and the right eye 33 of the user of the VR head-mounted display device. The first polarizer 11 has a first polarization direction, and the second polarizer 44 has a second polarization direction.

For example, in the VR head-mounted display device of the embodiment of the present disclosure, two display images having different polarization directions are output by a single screen, and two polarizers are disposed between the two convex lenses and the eyes of the user. The polarization directions of the two polarizers are respectively the same as, and correspond to the polarization directions of the two display images output by the display screen 77. When the user uses the device, the two eyes can respectively only see the display image of one of the polarization directions on the display screen 77. In this way, the images seen by the two eyes of the user are synthesized to be a stereoscopic image through the brain. In conjunction with FIG. 1, the lens barrel baffle 8 in the middle of the lens and the display screen is eliminated, and the screen range 88 visible to the observer by one eye is significantly increased compared to the screen range 7 seen by the dual screens system. In this way, the embodiment of the present disclosure greatly increases the angle of visual field of the system, and brings a better visual experience and a sense of substitution to the user.

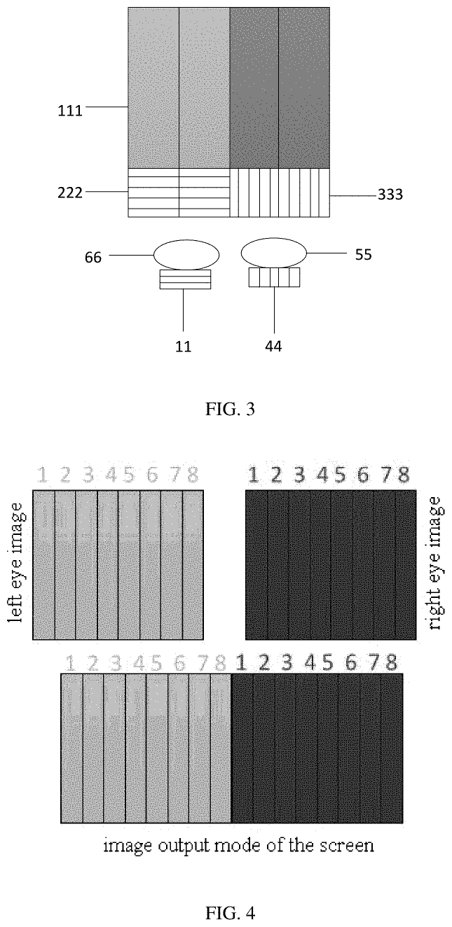

As shown in FIG. 3, the display screen 77 includes: a display component 111; third polarizers 222 having the first polarization direction, disposed in a light exiting direction of the display component for outputting the first display image; fourth polarizers 333 having the second polarization direction, disposed in the light exiting direction of the display component for outputting the second display image.

The third polarizers 222 are of a first polarizer group. Positions of the polarizers in the first polarizer group correspond to positions of odd columns of pixels of the display component 111. The fourth polarizers 333 are of a second polarizer group. The positions of the polarizers in the second polarizer group correspond to positions of even column pixels of the display component 111. In the present embodiment, although the pixels of the display component are divided into odd columns and even columns, those skilled in the art can understand that this scheme can also be implemented by dividing the pixels of the display component into odd rows and even rows.

For example, in the embodiment of FIG. 3, dark color in the display component 111 represents the even columns of pixels, and light color in the display component 111 represents the odd columns of pixels. The third polarizers 222 are disposed on a surface of the odd columns of pixels of the light color, and the fourth polarizers 333 are disposed on a surface of the even columns of pixels of the dark color. Only light in the horizontal direction can pass through the third polarizers 222 on the surface of the odd columns of pixels, and only the light in the vertical direction can pass through the fourth polarizers 333 on the surface of the even columns of pixels. Since the polarization direction of the first polarizer 11 is consistent with the polarization direction of the third polarizers 222, and the polarization direction of the second polarizer 44 is consistent with the polarization direction of the fourth polarizers 333, when the user observes through the first convex lens 66, only the light emitted by the odd columns of pixels can be seen, and when observing through the second convex lens 55, only the light emitted by the even columns of pixels can be seen. In this way, when the two eyes of the user simultaneously observe from the two lenses, the image of the entire screen can be seen, and mutual interference between the left and right eyes is avoided, and the observation line of sight can not be blocked by any baffle, which significantly increases the angle of visual field of the system.

For example, the display component 111 in the embodiment of the present disclosure is an LCD display component or an OLED display component. The third polarizers 222 and the fourth polarizers 333 are attached to a surface of a light exiting direction of the display component 111. The third polarizers 222 and the fourth polarizers 333 select a linear polarizer, so that the light emitted by the display component 111 is a linearly polarized light. In this way, two images are output on the same screen, and the two images enter the left eye and the right eye of the user respectively without affecting each other, allowing the observer to have a stereoscopic visual sense.

For example, in order to make the visual effect better, the first polarizer 11 and the second polarizer 44 are respectively attached to a surface of the first convex lens facing the left eye and a surface of the second convex lens facing the right eye. In this way, the distance between the polarizer and the convex lens is minimized to prevent the intermediate light from diverging to affect the visual experience. For example, the attachment here can be coating or plating.

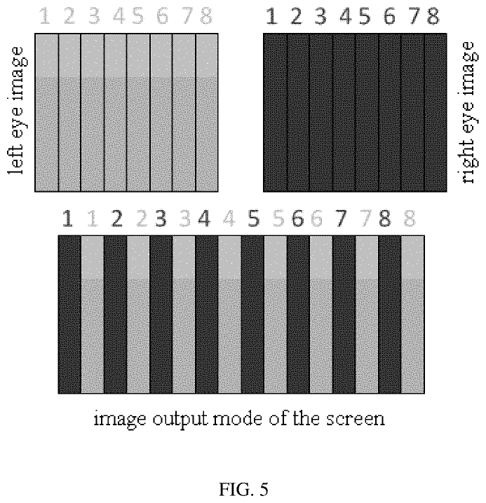

As shown in FIG. 4, in combination with FIG. 3, the display screen outputs two images with different polarization directions, corresponding to the left eye image and the right eye image, respectively, and the left eye image and the right eye image are output on the screen in the arrangement in the figure. For example, the right half pixels of the screen (represented by the dark color) are output for the right eye image, and the left half pixels of the screen (represented by the light color) are output for the left eye image. In this way, when the user observes the image with two eyes, the overlap region of the left eye and the right eye can see the image of the entire screen, and the two images respectively enter the left eye and the right eye of the user without affecting each other, allowing the observer to have a stereoscopic visual sense.

For example, as shown in FIG. 5, an embodiment of the present disclosure can also design the display screen that the even columns of pixels (represented by the dark color) of the screen output the right eye image, and the odd columns of pixels (represented by the light color) of the screen output the left eye image. In this way, when the user observes the image with the two eyes, the odd columns of pixels and the even columns of pixels are evenly and alternately arranged to form the entire screen image, so that the user can see more uniform pictures. For example, the screen outputs the left eye image and the right eye image interlacedly, that is, the binocular images are simultaneously present on the screen, which is more difficult for the user being conscious of the change and the sense of substitution is stronger than refreshing the screen using the time-division multiplexing technique.

An embodiment of the present disclosure further provides a method of performing VR display by using the VR head-mounted display device described above, including: the display screen simultaneously outputting a first display image having the first polarization direction and a second display image having the second polarization direction, the first polarization direction being orthogonal to the second polarization direction; the first convex lens and the second convex lens respectively enlarging the first display image and the second display image; the first polarizer outputting the enlarged first display image to the left eye of the user, and the second polarizer outputting the enlarged second display image to the right eye of the user.

For example, two kinds of polarizers whose polarization directions are orthogonal to each other can be disposed in front of the display component of the display screen, and the polarizers of the first polarization direction are disposed at the positions of the odd columns of pixels of the display screen, and the polarizers of the second polarization direction are disposed at the positions of the even columns of pixels of the display screen. In this way, the left eye or the right eye of the user separately receives an image having one of the polarization directions. When the two eyes see the screen at the same time, the image of the entire display screen can be received, and the visible screen range is significantly increased, which significantly increases the angle of visual field of the system and improves the sense of substitution and experience of the user.

An embodiment of the present disclosure also provides an external VR system, including the VR head-mounted display device described in the above embodiments and a data processing unit. The data processing unit is connected with the VR head-mounted display device through a data line, and the data is processed and sent to the VR head-mounted display device for display. The processing speed is fast, and quality of the played picture is high.

An embodiment of the present disclosure also discloses an integrated VR display system, including the VR head-mounted display device described in the above embodiments and a data processing unit. The data processing unit is disposed inside the VR head-mounted display device, without external data line limitation, which is easy to carry.

The described above are only exemplary embodiments of the present disclosure, and the present disclosure is not intended to be limited thereto. For one of ordinary skill in the art, various changes and alternations may be readily contemplated without departing from the technical scope of the present disclosure, and all of these changes and alternations shall fall within the scope of the present disclosure.

1. A VR head-mounted display device, comprising:
a display screen configured to simultaneously output a first display image having a first polarization direction and a second display image having a second polarization direction, wherein the first polarization direction is orthogonal to the second polarization direction;
a first convex lens configured to enlarge the first display image and a second convex lens configured to enlarge the second display image; and
a first polarizer disposed between the first convex lens and a left eye of a user of the VR head-mounted display device, and a second polarizer disposed between the second convex lens and a right eye of the user of the VR head-mounted display device, wherein the first polarizer has a first polarization direction and the second polarizer has a second polarization direction.

2. The VR head-mounted display device according to claim 1, wherein the display screen comprises:
a display component;
third polarizers having the first polarization direction, disposed in a light exiting direction of the display component, and configured to output the first display image; and
fourth polarizers having the second polarization direction, disposed in the light exiting direction of the display component, and configured to output the second display image.

3. The VR head-mounted display device according to claim 2, wherein
the third polarizers are a first polarizer group, wherein positions of the polarizers in the first polarizer group correspond to positions of odd columns of pixels of the display component; and
the fourth polarizers are a second polarizer group, wherein positions of the polarizers in the second polarizer group correspond to positions of even columns of pixels of the display component.

4. The UR head-mounted display device according to claim 3, wherein the display component is an LCD display component or an OLED display component, and the third polarizers and the fourth polarizers are attached to a surface of the light exiting direction of the display component.

5. The VR head-mounted display device according to claim 4, wherein the third polarizers and the fourth polarizers are linear polarizers.

6. The VR head-mounted display device according to claim 5, wherein the first polarizer and the second polarizer respectively are a polarizing film formed on a surface of the first convex lens facing the left eye and a polarizing film formed on a surface of the second convex lens facing the right eye.

7. A method of performing VR display by using the VR head-mounted display device according to claim 1, comprising:
the display screen simultaneously outputting the first display image having the first polarization direction and the second display image having the second polarization direction, wherein the first polarization direction is orthogonal to the second polarization direction;
the first convex lens and the second convex lens respectively enlarging the first display image and the second display image; and
the first polarizer outputting the enlarged first display image to the left eye of the user, and the second polarizer outputting the enlarged second display image to the right eye of the user.

8. The method according to claim 7, wherein the display screen comprises a display component, third polarizers having a first polarization direction, and fourth polarizers having a second polarization direction, and
the method comprises:
disposing the third polarizers in the light exiting direction of the display component to output the first display image; and
disposing the fourth polarizers in the light exiting direction of the display component to output the second display image.

9. The method according to claim 8, wherein
the third polarizers form the first polarizer group, and the fourth polarizer form the second polarizer group, and the method comprises:
disposing the positions of the polarizers in the first polarizer group corresponding to the positions of the odd columns of pixels of the display screen; and
disposing the positions of the polarizers in the second polarizer group corresponding to the positions of the even columns of pixels of the display screen.

10. An external VR display system, comprising, the VR head-mounted display device according to claim 1.

11. An integrated UR display system, comprising, the VR head-mounted display device according to claim 1.

12. The VR head-mounted display device according to claim 2, wherein the display component is an LCD display component or an OLED display component, and the third polarizers and the fourth polarizers are attached to a surface of the light exiting direction of the display component.

13. The VR head-mounted display device according to claim 2, wherein the third polarizers and the fourth polarizers are linear polarizers.

14. The VR head-mounted display device according to claim 3, wherein the third polarizers and the fourth polarizers are linear polarizers.

15. The VR head-mounted display device according to claim 1, wherein the first polarizer and the second polarizer respectively are a polarizing film formed on a surface of the first convex lens facing the left eye and a polarizing film formed on a surface of the second convex lens facing the right eye.

16. The VR head-mounted display device according to claim 2, wherein the first polarizer and the second polarizer respectively are a polarizing film formed on a surface of the first convex lens facing the left eye and a polarizing film formed on a surface of the second convex lens facing the right eye.

17. The VR head-mounted display device according to claim 3, wherein the first polarizer and the second polarizer respectively are a polarizing film formed on a surface of the first convex lens facing the left eye and a polarizing film formed on a surface of the second convex lens facing the right eye.

18. The UR head-mounted display device according to claim 4, wherein the first polarizer and the second polarizer respectively are a polarizing film formed on a surface of the first convex lens facing the left eye and a polarizing film formed on a surface of the second convex lens facing the right eye.
